(19) United States
(12) Patent Application Publication
(10) Pub. No.: US 2008/0160815 A1
(43) Pub. Date: Jul. 3, 2008

(54) Electrical connector

(75) Inventor: Ted Ju, Anloku (TW)

Correspondence Address: REED SMITH LLP, Suite 1400, 3110 Fairview Park Drive, Falls Church, VA, 22042, US

(73) Assignee: Lotes Co., Ltd.

(21) Appl. No.: 11/882,995

(22) Filed: Aug. 8, 2007

(30) Foreign Application Priority Data
Dec. 30, 2006 (CN) 200610132459.2

(51) Int. Cl. H01R 13/62

(52) U.S. Cl. 439/331

(57) ABSTRACT

An electrical connector capable of being electrically connected to an electronic component comprises an insulating body and a plurality of conductive terminals. The insulating body thereon has a plurality of terminal receiving holes, and the conductive terminals are accommodated in the terminal receiving holes. At least one end of the conductive terminals is provided with a contact portion higher than a surface of the terminal receiving holes. The electronic component thereon has a contact pad, and the contact portion of the conductive terminal contacts the contact pad. The conductive terminals are made of copper with electric conductivity larger than 80% IACS, and the contact pad is non-goldplated. The electrical connector of the invention reduces manufacture cost and assures good contact between the electrical connector and the circuit board.

### BACKGROUND OF THE INVENTION

1. Field of the Invention

The present invention relates to an electrical connector and, more particularly, to an electrical connector used to connect a Land Grid Array chip module.

2. Description of the Prior Art

Currently, an electrical connector is generally used to electrically connect the chip module to the circuit board, and the electrical connector usually is connected to the circuit board using two methods. The first method is that the terminals of the connector are soldered with the solder pad on the circuit board. The material of the terminal is copper alloy, and the solder pad on the circuit board is made of metallic coatings or organic coatings. Metallic coatings mainly contain immersion silver (ImAg), immersion tin (ImSn), etc., while organic coatings mainly contain organic solderability preservatives (OSP). The second method is that the terminals of the connector elastically contact the contact pads on the PCB. The material of the terminal has to be elastic, so the copper alloy is more appropriate due to the tensile strength above 450 Mpa and the electric conductivity below 80% IACS. The contact pads on the PCB are coated with gold because gold can protect contact pads against oxidization. Generally, the terminals of the connector and the goldplated contact pad can maintain the contact impedance below 30 microhm due to gold protection. If the material of the contact pads is replaced by immersion silver, immersion tin, or organic solderability preservatives, such material always oxidized without gold protection to form an oxide film causing the contact impedance above 30 microhm when the terminals contact it. However, most of the solder pads are treated with immersion silver, and some of the contact pads are goldplated. The solder pads and the contact pads on the same PCB are respectively processed by different surface treating processes, which are very expensive.

Thus, it is very necessary to design a novelty electrical connector to overcome the aforesaid problems.

### SUMMARY OF THE INVENTION

A scope of the invention is to provide an electrical connector, by which the manufacture cost can be reduced and the contact between the electrical connector and a circuit board can be ensured.

To achieve the aforesaid scope, the electrical connector of the invention, for electrical connecting an electronic component comprising: an insulating body thereon having a plurality of terminal receiving holes, and a plurality of conductive terminals being accommodated in the terminal receiving holes, at least one end of the conductive terminals being provided with a contact portion higher than a surface of the terminal receiving holes of the insulating body, wherein the conductive terminals are made of copper with electric conductivity larger than 80% IACS.

Compared to the prior art, since the conductive terminals of the invention are made of copper with electric conductivity larger than 80% IACS, and the contact pad is non-goldplated, the manufacture cost can be reduced and the contact between the electrical connector and the circuit board can be ensured.

The advantage and spirit of the invention may be understood by the following recitations together with the appended drawings.

### BRIEF DESCRIPTION OF THE APPENDED DRAWINGS

FIG. 1 is a sectional view illustrating the electrical connector of the invention.

FIG. 2 is schematic diagram illustrating the electrical connector of the invention before being assembled with the circuit board and chip module.

FIG. 3 is a schematic diagram illustrating part of the electrical connector of the invention after being assembled with the circuit board and chip module.

### DETAILED DESCRIPTION OF THE INVENTION

The following embodiments along with the appended drawings are used to describe the electrical connector of the invention.

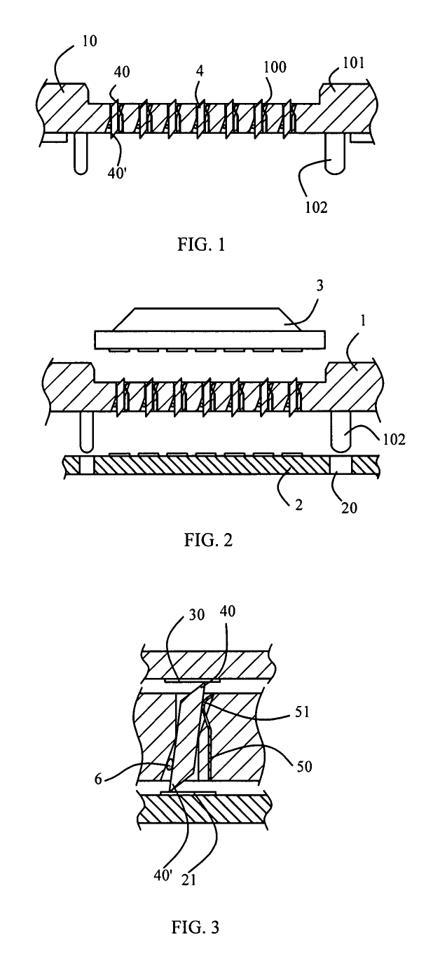

As shown in FIGS. 1 to 3, the electrical connector 1 can be electrically connected to the circuit board 2 and the chip module 3 (or connected to a circuit board and another circuit board or other electronic components). The electrical connector 1 comprises an insulating body 10 and a plurality of conductive terminals 4. The insulating body 10 thereon has a plurality of terminal receiving holes 100, and the conductive terminals 4 are accommodated in the terminal receiving holes 100. A positioning frame 101 is configured around the insulating body 10 to position the chip module 3. A positioning bar 102 is configured on one side of the insulating body 10 and capable of cooperating with the positioning hole 20 on the circuit board 2 to position the electrical connector 1 onto the circuit board 2. The positioning bar 102 may have different size to prevent the positioning bar 102 from mis-inserting the positioning hole 20.

Two ends of the conductive terminals 4 are respectively provided with terminal holding holes 100 higher than two contact portions 40, 40′ of the upper and lower surface of the insulating body 10 to elastically and electrically contact the circuit board 2 and the chip module 3. The circuit board 2 is provided with contact pad 21. One contact portion 40′ of the conductive terminals 40 can elastically contact the contact pad 21, and the chip module 30 is provided with a spacer 30. The other contact portion 40 of the conductive terminals 4 can elastically contact the spacer 30. The material of the conductive terminal 4 is copper with electric conductivity larger than 80% IACS. The copper can be C1100 (or other copper such as C1010 or C1020, C1100, C1010 or C1020 complies with JIS) with copper content not less than 99% and tensile strength lower than 450 Mpa. The surface of the contact pad 40′ is treated with immersion silver (or immersion tin, organic solderability preservatives). The copper with electric conductivity larger than 80% IACS and tensile strength lower than 450 Mpa and the contact pad of the circuit board treated with immersion silver, immersion tin, or organic solderability preservatives can maintain contact impedance lower than 30 microhm because good electric conductivity can reduce the effect of oxide film. The electrical connector 1 is provided with elastic support to support the terminals. In this practical application, one side of the conductive terminals 4 is provided with a support 5 made of elastic metal material. The support 5 comprises a fixing portion 50 to fix it to the insulating body 10 and an elastic portion 51 stretched by the fixing portion 50. The elastic portion 51 can support the conductive terminals 4. The other side of the conductive terminals 4 is provided with a supporting ball 6 made of elastic polymer material. The supporting ball 6 can support the conductive terminals 4 (two sides of the conductive terminals also can be provided with the support or the supporting ball to achieve the same function). When the circuit board 2 is connected to the chip module 3, the conductive terminals 4 will deflect to elastically deform the elastic portion 51 and the supporting ball 6 of the support 5 and further provide enough elasticity to connect elastically and electrically the electrical connector 1 to the circuit board 2 and the chip module 3.

Since the conductive terminals of the invention are made of copper with electric conductivity larger than 80% IACS, and the contact pad is non-goldplated, the manufacture cost can be reduced and the contact between the electrical connector and the circuit board can be ensured. With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An electrical connector for electrical connecting an electronic component comprising:
an insulating body thereon having a plurality of terminal receiving holes; and
a plurality of conductive terminals being accommodated in the terminal receiving holes, at least one end of the conductive terminals being provided with a contact portion higher than a surface of the terminal receiving holes of the insulating body, wherein the conductive terminals are made of copper with electric conductivity larger than 80% IACS.

2. The electrical connector of claim 1 characterized in that: the conductive terminals made of copper has a tensile strength lower than 450 Mpa.

3. The electrical connector of claim 1 characterized in that: the copper is C1100, C1010, or C1020.

4. The electrical connector of claim 1 characterized in that: the electrical connector is provided with elastic support to support the terminals.

5. The electrical connector of claim 4 characterized in that: the elastic support is made of elastic metal.

6. The electrical connector of claim 4 characterized in that: the elastic support is made of elastic polymer.

7. The electrical connector of claim 1 characterized in that: the insulating body is provided with a positioning pillar.

8. The electrical connector of claim 1 characterized in that: two ends of the terminal are respectively higher than an upper surface and a lower surface of the holding holes of the insulating body.

9. The electrical connector of claim 1 characterized in that: the insulating body is provided with a positioning frame.

10. The electrical connector of claim 1 characterized in that: the electronic component is a circuit board or a chip module, one end of the terminal contacts the circuit board, and the other end contacts the chip module.

11. An electrical connector assembly comprising:
an electrical connector comprising:
an insulating body thereon having a plurality of terminal receiving holes; and
a plurality of conductive terminals being accommodated in the terminal receiving holes, at least one end of the conductive terminals being provided with a contact portion higher than a surface of the terminal receiving holes of the insulating body, wherein the conductive terminals are made of copper with electric conductivity larger than 80% IACS; and
an electronic component thereon having a plurality of contact pads, wherein the contact pads is non-goldplated connecting with the contact portion of the conductive terminal.

12. The electrical connector assembly of claim 11 characterized in that: a surface of the contact pad is treated with immersion silver.

13. The electrical connector assembly of claim 11 characterized in that: a surface of the contact pad is treated with immersion tin.

14. The electrical connector assembly of claim 11 characterized in that: a surface of the contact pad is treated with organic solderability preservative (OSP).

15. The electrical connector assembly of claim 11 characterized in that: the conductive terminals made of copper has a tensile strength lower than 450 Mpa.
